(19) United States
(12) Patent Application Publication
(10) Pub. No.: US 2026/0341855 A1
(43) Pub. Date: Oct. 29, 2026

(54) SECONDARY BATTERY AND BATTERY PACK INCLUDING THE SECONDARY BATTERY

(71) Applicant: SAMSUNG SDI CO., LTD., Yongin-si (KR)

(72) Inventors: Dae Kyu KIM, Suwon-si (KR); Jong Jun PARK, Suwon-si (KR); Kwang Soo SEO, Suwon-si (KR)

(21) Appl. No.: 19/405,700

(22) Filed: Dec. 2, 2025

(30) Foreign Application Priority Data
Jan. 3, 2025 (KR) 10-2025-0000997

(51) Int. Cl. H01M 50/14; H01M 50/152; H01M 50/242; H01M 50/342; H01M 50/586

(52) U.S. Cl. CPC H01M 50/14; H01M 50/152; H01M 50/242; H01M 50/3425; H01M 50/586; H01M 2200/00

(57) ABSTRACT

A secondary battery includes a case including an opening portion and an electrode assembly arranged inside the case. An upper cap is arranged in the opening portion, and a lower cap is arranged to face the upper cap and connected to the electrode assembly. A vent plate is arranged between the upper cap and the lower cap. An insulator is arranged between the vent plate and the lower cap. An anti-rotation portion is provided to prevent relative rotation of the vent plate and the lower cap.

### CROSS REFERENCE TO RELATED APPLICATION

The present application claims priority to Korean Patent Application No. 10-2025-0000997, filed on Jan. 3, 2025, the entire contents of which is incorporated herein for all purposes by this reference.

### BACKGROUND OF THE DISCLOSURE

### Field of the Disclosure

The present disclosure relates to a secondary battery and a battery pack including the disclosure.

### Description of the Related Art

With the rapid spread of electronic devices using batteries, such as mobile phones, laptop computers, electric vehicles, etc., the demand for high energy density and high capacity secondary batteries is rapidly increasing. Accordingly, research and development to improve the performance of lithium secondary batteries is being actively conducted.

A lithium secondary battery includes a positive electrode and a negative electrode that contain active materials capable of intercalation and deintercalation of lithium ions, and an electrolyte, and produces electrical energy through oxidation and reduction reactions when lithium ions are intercalated/deintercalated from the positive electrode and the negative electrode.

The information disclosed in this section is provided for enhancement of understanding of the background of the present disclosure. It may contain information that does not constitute related or prior art.

### SUMMARY OF THE DISCLOSURE

The present disclosure provides a secondary battery and a battery pack including the secondary battery in which the performance of a current interrupt device (CID) may be stably secured by suppressing movement of the CID.

These and other aspects and features of the present disclosure will be described in or will be apparent from the following description of some embodiments of the present disclosure.

According to an aspect of the present disclosure, a secondary battery includes a case with an opening, an electrode assembly arranged inside the case, a upper cap arranged in the opening portion, a lower cap arranged to face the upper cap and connected to the electrode assembly, a vent plate arranged between the upper cap and the lower cap, an insulator arranged between the vent plate and the lower cap, and an anti-rotation portion that prevents relative rotation of the vent plate and the lower cap.

The vent plate may further include a first vent surface arranged to face the upper cap and a second vent surface arranged to face the lower cap.

A concave notch may be formed on the first vent surface or the second vent surface.

The insulator may include a crosslinked resin material.

The anti-rotation portion may be formed by surface treatment of a part of the lower cap facing the insulator.

The anti-rotation portion may be formed by punching a part of the lower cap facing the insulator.

The anti-rotation portion may include an uneven portion formed on the lower cap.

The uneven portion may include peaks and valleys continuously formed toward a center of the lower cap.

The uneven portion may include peaks and valleys continuously formed in a circumferential direction of the lower cap.

The anti-rotation portion may include a protrusion portion formed on the insulator, with the protrusion portion being received in the uneven portion.

The anti-rotation portion may include a reinforced uneven portion formed on a part of the vent plate that faces the insulator.

The anti-rotation portion may include a reinforced protrusion portion formed on the insulator, with the reinforced protrusion portion being received in the reinforced uneven portion.

A first bent portion may be formed on opposite sides of the vent plate, a second bent portion may be formed on opposite sides of the lower cap to correspond to the first bent portion, and the insulator may be forcedly fit between the first bent portion and the second bent portion.

The insulator may include a binding maintaining portion to maintain binding with the vent plate.

The binding maintaining portion may include a projection that protrudes toward a center of the insulator and is supported on the first bent portion.

The first bent portion may have a Z-shape bent structure including a lower bent portion and an upper bent portion, and the projection may be engaged with an upper portion of the lower bent portion.

A plurality of projections may protrude toward the center of the insulator from an inner circumferential surface of the insulator, with the projections being spaced from each other.

The binding maintaining portion may be formed by a part of the first bent portion being deformed by thermal deformation to fill a part of the insulator.

According to another aspect of the present disclosure, a battery pack includes a housing and secondary batteries arranged inside the housing, in which the secondary battery includes a case including an opening portion, an electrode assembly arranged inside the case, a upper cap arranged in the opening portion, a lower cap arranged to face the upper cap and connected to the electrode assembly, a vent plate arranged between the upper cap and the lower cap, an insulator arranged between the vent plate and the lower cap, and an anti-rotation portion that prevents relative rotation of the vent plate and the lower cap.

The anti-rotation portion may be formed by surface treatment or punching a part of the lower cap that faces the insulator.

However, the effects obtainable through the present disclosure are not limited to the above effects, and other technical effects that are not mentioned will be clearly understood by those skilled in the art from the following description of the present disclosure.

### BRIEF DESCRIPTION OF THE DRAWINGS

The drawings illustrate some embodiments of the present disclosure, and further describe aspects and features of the present disclosure together with the detailed description of the present disclosure. However, the present disclosure is not limited to embodiments depicted in the drawings.

FIG. 1 is a perspective view of a secondary battery according to a first embodiment of the present disclosure;

FIG. 2 is a cross-sectional view of the secondary battery according to the first embodiment of the present disclosure;

FIG. 3 is a view of a cap assembly according to the first embodiment of the present disclosure;

FIG. 4 is an enlarged view of a half region of the cap assembly of FIG. 3;

FIG. 5 is a perspective view of a lower cap according to the first embodiment of the present disclosure;

FIG. 6 is a plan view of the lower cap according to the first embodiment of the present disclosure;

FIG. 7 is an enlarged view of a half region of a cap assembly according to a second embodiment of the present disclosure;

FIG. 8 is a perspective view schematically showing a lower cap according to the second embodiment of the present disclosure;

FIG. 9 is a plan view of the lower cap to the second embodiment of the present disclosure;

FIG. 10 is a plan view of a modified example of the lower cap according to the second embodiment of the present disclosure;

FIG. 11 is an enlarged view of a half region of a cap assembly according to a third embodiment of the present disclosure;

FIG. 12 is a perspective view of a lower cap according to the third embodiment of the present disclosure;

FIG. 13 is a plan view of the lower cap according to the third embodiment of the present disclosure;

FIG. 14 is an enlarged view of a half region of a cap assembly according to a fourth embodiment of the present disclosure;

FIG. 15 is an exploded perspective view of an insulator and a lower cap according to a fourth embodiment of the present disclosure;

FIG. 16 is a view schematically showing a modified example of a cap assembly according to the fourth embodiment of the present disclosure;

FIG. 17 is an enlarged view of a half region of a cap assembly according to a fifth embodiment of the present disclosure;

FIG. 18 is a plan view of an insulator according to the fifth embodiment of the present disclosure;

FIG. 19 is an enlarged view of a modified example of the half region of the cap assembly according to the fifth embodiment of the present disclosure; and

FIG. 20 is a perspective view of a battery pack according to various embodiments of the present disclosure.

### DETAILED DESCRIPTION OF THE INVENTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein includes all sub-ranges of the same numerical precision subsumed within the recited range. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein.

References to two compared elements, features, etc., as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is arranged in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

Hereinafter, with reference to the attached drawings, a secondary battery and a battery pack including the secondary battery according to various embodiments of the present disclosure will be described. The thickness of lines and the size of components shown in the drawings may be exaggerated for clarity and convenience of description. The terms described below are defined in consideration of functions in the present disclosure and may vary depending on the intention or custom of users or operators. Therefore, these terms should be defined based on matters throughout the present specification.

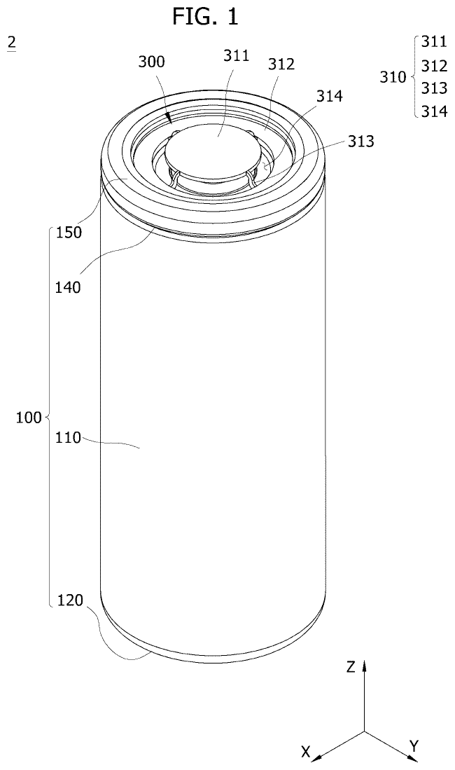

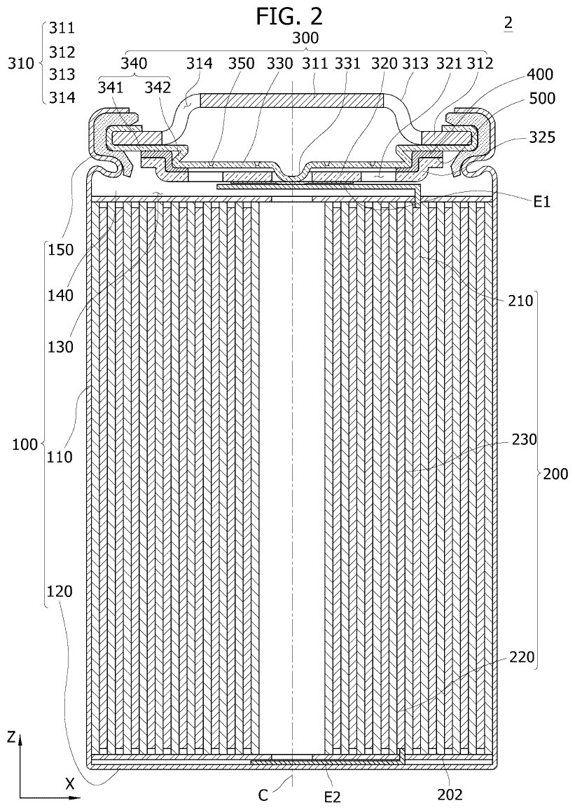

FIG. 1 is a perspective view of a secondary battery according to a first embodiment of the present disclosure, and FIG. 2 is a cross-sectional view of the secondary battery according to the first embodiment of the present disclosure.

Referring to FIGS. 1 and 2, a secondary battery 2 according to the an embodiment of the present disclosure may include a case 100, an electrode assembly 200, a cap assembly 300, and a rotation prevention unit 500.

The following description will be directed to an example where the secondary battery 2 is a cylindrical lithium-ion secondary battery. However, the present disclosure is not limited to this example, and the secondary battery 2 may be, for example, a lithium polymer battery or a prismatic battery.

The case 100 may form an exterior of the secondary battery 2. The case 100 may be electrically conductive. For example, the case 100 may include at least of steel, stainless steel, aluminum, and aluminum alloy. By being formed of such materials, the case 100 may protect the electrode assembly 200 from external impact and dissipate heat from a charging/discharging operation of the electrode assembly 200 to outside of the secondary battery 2.

The case 100 according to the current embodiment may include a cylindrical side wall portion 110. The central axis C of the case 100 described below may refer to a central axis of the side wall portion 110 of the case 100. Opposite ends of the side wall portion 110 that are perpendicular to the central axis C of the case 100 may be open.

The case 100 may further include a bottom portion 120 that closes a lower end of the side wall portion 110. The bottom portion 120 be disk shaped and may be positioned to face the lower end of the side wall portion 110. The bottom portion 120 may perpendicular to the central axis C of the case 100. A circumferential surface of the bottom portion 120 may be coupled to the lower end of the side wall portion 110. In some embodiments, the bottom portion 120 may be formed integrally with the side wall portion 110 through a drawing process, etc., and in other embodiments the bottom portion 120 may be manufactured separately from the side wall portion 110 and then coupled to the side wall portion 110 through welding, etc.

The case 100 may further include an opening 130 at an upper end of the side wall portion 110. The opening 130 may function to allowing the electrode assembly 200 (described later) to be inserted into the case 100 from an upper end region of the case 100 and thereby provide a path for the cap assembly 300 to be installed. The opening 130 according to the current embodiment may mean an empty space surrounded by the upper end of the side wall portion 110 located opposite to the bottom portion 120.

The case 100 according to the current embodiment may further include a beading portion 140. The beading portion 140 may protrude to the inner side of the case 100. The beading portion 140 may limit the cap assembly 300 from being inserted into the case 100 by a set distance or more and prevent the electrode assembly 200 from being removed from the case 100.

The beading portion 140 may be arranged at the upper end of the side wall portion 110. The beading portion 140 may be formed such that a central portion is concave toward the central axis C of the case 100. The beading portion 140 may be formed integrally with the side wall portion 110. In other embodiments, the beading portion 140 may be manufactured separately from the side wall portion 110 and then coupled to the side wall portion 110.

Hereinafter, the secondary battery 2 according to the current embodiment will be described as an example including the beading portion 140. But the present disclosure is not limited thereto, and the beading portion 140 may be omitted in other embodiments of the present disclosure.

The inner side of the case 100 may be filled with an electrolyte. The electrolyte may be injected into the inner side of the case 100 through the opening 130 of the case 100.

The electrode assembly 200 may function as a unit structure that performs a charging/discharging operation of power in the secondary battery 2. The electrode assembly 200 may include a first electrode 210, a second electrode 220, and a separator 230 arranged between the first electrode 210 and the second electrode 220.

The electrode assembly 200 may be accommodated inside the case 100. The electrode assembly 200 may be inserted into the inner side of the case 100 through the opening 130 of the case 100.

The electrode assembly 200 may be a cylindrical shape with a winding hole formed in a central portion thereof. More specifically, the first electrode 210, the separator 230, and the second electrode 220 may be stacked and then the electrode assembly 200 may be wound clockwise or counterclockwise around the winding hole. Accordingly, the electrode assembly 200 may have an approximately jelly roll shape. A central axis of the winding hole may be arranged coaxially with the central axis C of the case 100. A cross-sectional shape of the electrode assembly 200 may be various shapes, such as an oval, a polygon, etc., as well as a circle.

The first electrode 210, the separator 230, and the second electrode 220 may be sequentially arranged in a concentric circle along a radial direction of the electrode assembly 200 from the winding hole. Opposite ends of the first electrode 210, the second electrode 220, and the separator 230, which are parallel to the central axis C of the case 100, may be positioned to face the bottom portion 120 and the opening portion 130 of the case 100.

The first electrode 210 may function as a positive electrode of the electrode assembly 200. The first electrode 210 may be formed of a foil including a metal material such as aluminum or an aluminum alloy. But the type, size, shape, etc., of the first electrode 210 may not be particularly limited as long as the first electrode 210 is conductive and does not cause a chemical change in the secondary battery 2.

The first electrode 210 may be electrically connected to the cap assembly 300. In such an arrangement, when the first electrode 210 functions as the positive electrode of the electrode assembly 200, the cap assembly 300 may function as a positive-electrode terminal of the secondary battery 2. In an example, the first electrode 210 may be electrically connected to the cap assembly 300 by a first electrode tab E1.

The first electrode tab E1 may include a conductive metal material such as copper, a copper alloy, nickel, or a nickel alloy. The first electrode tab E1 may be positioned on an upper side of the electrode assembly 200, and opposite ends thereof may be connected to the first electrode 210 and the cap assembly 300. One end of the first electrode tab E1 may be directly connected to the first electrode 210, or the first electrode tab E1 may be indirectly connected to the first electrode 210 via a separate collector plate (not shown) connected to the first electrode 210.

A first active material layer may be applied to at least a part of the first electrode 210. In some embodiments, the first active material layer may be applied to opposite surfaces of the first electrode 210, in other embodiments the first active material layer may be applied to one of the surfaces of the first electrode 210.

As the first electrode 210 functions as a positive electrode, the first active material layer may include a positive-electrode active material. The positive-electrode active material may be a compound capable of reversible intercalation and deintercalation of lithium (a lithiated intercalation compound). More specifically, one or more of compound oxides of lithium and a metal selected from cobalt, manganese, nickel, iron, and combinations thereof may be used.

As examples, the positive-electrode active material may include at least one of a lithium-iron-phosphorus oxide (LiFePO₄, LFP), a lithium-manganese-iron-phosphorus oxide (LiMnFePO₄, LMFP), and a lithium-nickel-cobalt-manganese oxide (LiNixCoyMnzO₂, LNCM). Here, conditions of 0<x<1, 0<y<1, 0<z<1, x+y+z=1 may be satisfied. The positive-electrode active material may include any one of a lithium iron phosphorus oxide (LiFePO₄, LFP), a lithium manganese iron phosphorus oxide (LiMnFePO₄, LMFP), and a lithium nickel cobalt manganese oxide (LiNixCoyMnzO₂, LNCM), or may include any two or all of the lithium iron phosphorus oxide (LiFePO₄, LFP), the lithium manganese iron phosphorus oxide (LiMnFePO₄, LMFP), and the lithium nickel cobalt manganese oxide (LiNixCoyMnzO₂, LNCM).

The first active material layer may further include a positive-electrode conductive material. The positive-electrode conductive material may be used to provide conductivity to the first active material layer, and any material that is electronically conductive and does not cause a chemical change in the secondary battery may be used. Examples of the positive-electrode conductive material include carbon-based materials such as natural graphite, artificial graphite, carbon black, acetylene black, Ketjen black, carbon fibers, carbon nanofibers, carbon nanotubes, etc.; metal-based materials in the form of metal powder or metal fibers containing copper, nickel, aluminum, silver, etc.; conductive polymers such as polyphenylene derivatives, etc.; or mixtures thereof.

The first active material layer may further include a positive-electrode binder. The positive-electrode binder may attach particles of the positive-electrode active material to each other and also to attach the positive-electrode active material to the first electrode 210.

The positive-electrode binders may include non-aqueous binders, aqueous binders, dry binders, or combinations thereof.

Examples of the non-aqueous binders may include polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenol resin, epoxy resin, polyvinyl alcohol, and combinations thereof.

When an aqueous binder is used as a positive-electrode binder, a cellulose-based compound capable of giving viscosity may be further included. For such a cellulose series compound, one or more of carboxymethyl cellulose, hydroxypropyl methyl cellulose, methyl cellulose, alkali metal salts thereof, etc., may be used in mixture. Na, K or Li may be used as the alkali metal.

The dry binder may be a fiberizable polymeric material, such as polytetrafluoroethylene, polyvinylidene fluoride, a polyvinylidene fluoride-hexafluoropropylene copolymer, a polyethylene oxide, or a combination thereof.

The second electrode 220 may function as a negative electrode of the electrode assembly 200. The second electrode 220 may be formed from a foil including a metal material such as copper, a copper alloy, nickel, or a nickel alloy. The second electrode 220 may be arranged to face the first electrode 210 at a predetermined distance from the first electrode 210.

The second electrode 220 may be electrically connected to the case 100. For example, the second electrode 220 may be electrically connected to the case 100 by a second electrode tab E2. When the second electrode 220 functions as the negative electrode of the electrode assembly 200, the case 100 may function as a negative-electrode terminal of the secondary battery 2. The second electrode tab E2 may include a conductive metal material such as copper, a copper alloy, nickel, or a nickel alloy. The second electrode tab E2 may be positioned on a lower side of the electrode assembly 200, and opposite ends of the second electrode tab E2 may be connected to the second electrode 220 and the bottom portion 120 of the case 100. One end of the second electrode tab E2 may be directly connected to the second electrode 220, or the end of the second electrode tab E2 may be indirectly connected to the second electrode 220 via a separate collector plate (not shown) connected to the second electrode 220. Type, size, shape, etc., of the second electrode 220 is not particularly limited as long as the second electrode 220 is conductive and does not cause a chemical change in the secondary battery 2.

A second active material layer may be applied to at least a part of the second electrode 220. In some embodiments, the second active material layer may be applied to opposite surfaces of the second electrode 220. In other embodiments, the second active material layer may be applied to one of the surfaces of the second electrode 220.

As the second electrode 220 functions as a negative electrode, the second active material layer may include a negative-electrode active material. Examples of the negative-electrode active material include a material capable of reversibly intercalating/deintercalating lithium ions, lithium metal, an alloy of lithium metal, a material capable of being doped and dedoped on lithium, or a transition metal oxide.

Examples of the material capable of reversibly intercalating/deintercalating lithium ions include a carbon-based negative-electrode active material, such as crystalline carbon, amorphous carbon, or a combination thereof. Examples of the crystalline carbon include graphite, such as natural graphite or artificial graphite in amorphous, plate-like, flake-like, spherical, or fibrous forms, and examples of the amorphous carbon include soft carbon or hard carbon, mesophase pitch carbide, calcined coke, etc.

As an alloy of lithium metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As a material that may be doped and dedoped on lithium, a Si-based negative-electrode active material or a Sn-based negative-electrode active material may be used. Examples of the Si-based negative-electrode active material include silicon, a silicon-carbon composite, SiOx (x=1 or 2), a Si—Q alloy, or a combination thereof. In the formula Si—Q, Q is selected from an alkali metal, an alkaline earth metal, a Group 13 element, a Group 14 element (excluding Si), a Group 15 element, a Group 16 element, a transition metal, a rare earth element, and combinations thereof. Examples of the Sn-based negative-electrode active material are Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on the surfaces of the silicon particles. For example, the silicon-carbon composite may include a secondary particle (core) in which silicon primary particles are assembled and an amorphous carbon coating layer (shell) positioned on the surface of the secondary particle. The amorphous carbon may also be located between silicon primary particles, such that, for example, the silicon primary particles may be coated with amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer positioned on the surface of the core.

An Si-based negative-electrode active material or an Sn-based negative-electrode active material may be used in mixture with a carbon-based negative-electrode active material.

The second active material layer may further include a negative-electrode binder.

The negative-electrode conductive material may be used to provide conductivity to the second active material layer. Any material that is electronically conductive and does not cause a chemical change in the secondary battery may be used. Examples of the negative-electrode conductive material may include carbon-based materials such as natural graphite, artificial graphite, carbon black, acetylene black, Ketjen black, carbon fibers, carbon nanofibers, carbon nanotubes, etc.; metal-based materials in the form of metal powder or metal fibers containing copper, nickel, aluminum, silver, etc.; conductive polymers such as polyphenylene derivatives, etc.; or mixtures thereof.

The negative-electrode binder may attach particles of the negative-electrode active material to each other and also to attach the negative-electrode active material to the second electrode 220.

Examples of the negative-electrode binders include non-aqueous binders, aqueous binders, dry binders, or combinations thereof.

Examples of the non-aqueous binders include polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenol resin, epoxy resin, polyvinyl alcohol, and combinations thereof.

When an aqueous binder is used as a negative-electrode binder, a cellulose-based compound capable of increasing viscosity may be further included. For such a cellulose series compound, one or more of carboxymethyl cellulose, hydroxypropyl methyl cellulose, methyl cellulose, alkali metal salts thereof, etc., may be used in mixture. Na, K or Li may be used as the alkali metal.

The dry binder may be a fiberizable polymeric material, such as polytetrafluoroethylene, polyvinylidene fluoride, a polyvinylidene fluoride-hexafluoropropylene copolymer, a polyethylene oxide, or a combination thereof.

The separator 230 may be arranged between the first electrode 210 and the second electrode 220. The separator 230 may function prevent a short circuit between the first electrode 210 and the second electrode 220 while allowing movement of lithium ions between the first electrode 210 and the second electrode 220.

As the separator 230, polyethylene, polypropylene, polyvinylidene fluoride, or a multilayer of two or more thereof may be used, and a mixed multilayer such as a two-layer separator of polyethylene/polypropylene, a three-layer separator of polyethylene/polypropylene/polyethylene, or a three-layer separator of polypropylene/polyethylene/polypropylene may be used.

The separator 230 may include a porous substrate and a coating layer including an organic material, an inorganic material, or a combination thereof. The coating layer may be provided on one or opposite surfaces of the porous substrate.

The porous substrate may be a polymer selected from polyolefins such as polyethylene, polypropylene, etc., polyesters such as polyethylene terephthalate, polybutylene terephthalate, etc., polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, teflon, and polytetrafluoroethylene, or a copolymer or mixture of two or more thereof.

The organic material may include a polyvinylidene fluoride-based polymer or a (meth)acrylic-based polymer.

The inorganic material may include inorganic particles selected from, but not limited to, Al₂O₃, SiO₂, TiO₂, SnO₂, CeO₂, MgO, NiO, CaO, GaO, ZnO, ZrO₂, Y2O₃, SrTiO₃, BaTiO₃, Mg(OH)₂, boehmite, and combinations thereof.

The organic and inorganic materials may be in mixture in a single coating layer. In other embodiments, a coating layer containing the organic material and a coating layer containing the inorganic material may be stacked.

A first insulating plate 201 and a second insulating plate 202 may be arranged on opposite sides of the electrode assembly 200. The first insulating plate 201 and the second insulating plate 202 may include an insulating material such as rubber, polyethylene (PE), polypropylene (PP), polyethylene terephthalate (PET), etc.

The first insulating plate 201 may be formed in a disk shape. The first insulating plate 201 may be arranged between a top surface of the electrode assembly 200 and the cap assembly 300. Accordingly, the first insulating plate 201 may block the electrode assembly 200 from directly contacting the cap assembly 300 and between insulate the electrode assembly 200 from the cap assembly 300. A through hole (not shown) through which the first electrode tab E1 may pass may be formed in the first insulating plate 201.

The second insulating plate 202 may be disk shaped. The second insulating plate 202 may be arranged between a bottom surface of the electrode assembly 200 and the bottom portion 120 of the case 100. Accordingly, the second insulating plate 202 may prevent the electrode assembly 200 from directly contacting the bottom portion 120 of the case 100, and the second insulating plate 202 may insulate between the electrode assembly 200 from the bottom portion 120 of the case 100. A through hole (not shown) through which the second electrode tab E2 may pass may be formed in the second insulating plate 202.

The cap assembly 300 may be coupled to the case 100 and may be positioned facing the electrode assembly 200. The cap assembly 300 may seal the case 100. For example, the cap assembly 300 may be arranged on the upper end of the side wall portion 110, that is, on the open side 130. The cap assembly 300 may be positioned to face the electrode assembly 200 in a direction parallel to the central axis C of the electrode assembly 200 and the case 100.

The cap assembly 300 may be electrically connected to the first electrode 210 by the first electrode tab E1. When the first electrode 210 functions as the positive electrode of the electrode assembly 200, the cap assembly 300 may function as the positive-electrode terminal of the secondary battery 2.

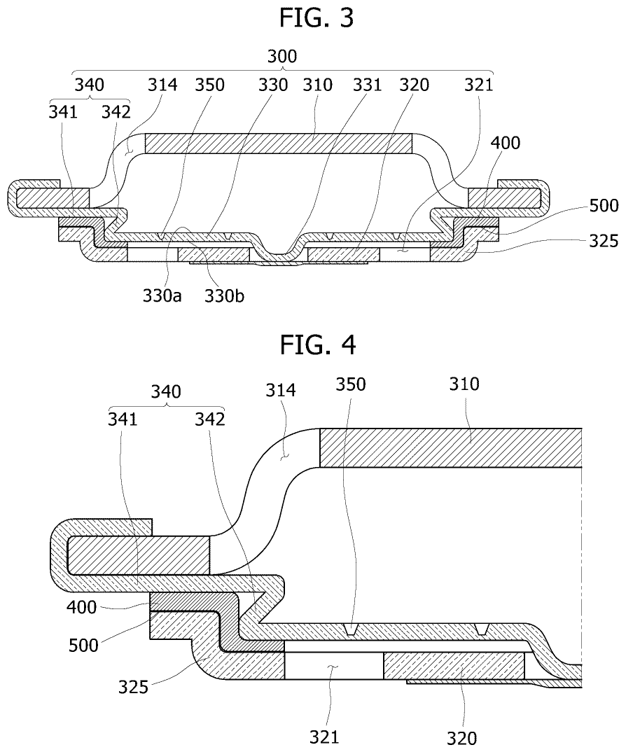

FIG. 3 is a view of a cap assembly according to the first embodiment of the present disclosure, and FIG. 4 is an enlarged view of a half region of the cap assembly of FIG. 3.

Referring to FIGS. 1 to 4, the cap assembly 300 may include an upper cap 310, a lower cap 320, a vent plate 330, an extension portion 340, and an insulator 400.

The upper cap 310 may form an upper exterior of the cap assembly 300. The upper cap 310 may be electrically connected to the first electrode 210 by the lower cap 320 and the vent plate 330. A central axis of the upper cap 310 may be arranged coaxially with the central axis C of the case 100. A central portion of the upper cap 310 may protrude to an outer side of the case 100. The upper cap 310 may include an electrically conductive material such as nickel, aluminum, copper, etc.

The upper cap 310 may include a small-diameter portion 311, a large-diameter portion 312, and a bridge 313.

The small-diameter portion 311 and the large-diameter portion 312 may be disk shaped with different diameters. In particular, the diameter of the small-diameter portion 311 may be less than the diameter of the large-diameter portion 312. The small-diameter portion 311 and the large-diameter portion 312 may be arranged such that their central axes are coaxial with the central axis C of the case 100. And the small-diameter portion 311 and the large-diameter portion 312 may be arranged to face each other in a first direction. In some embodiment, the small-diameter portion 311 may be arranged on the large-diameter portion 312, and the small-diameter portion 311 may protrude to the outer side of the case 100. The large-diameter portion 312 may have a ring shape with a hole formed in a central portion thereof.

The bridge 313 may be arranged between the small-diameter portion 311 and the large-diameter portion 312. Opposite ends of the bridge 313 may be connected to an outer circumferential surface of the small-diameter portion 311 and an outer circumferential surface of the large-diameter portion 312. The bridge 313 may have a curved shape extending from the small-diameter portion 311 toward the large-diameter portion 312.

A upper cap hole 314 may be formed in the upper cap 310 to discharge gas generated inside the case 100 to outside of the case 100. The upper cap hole 314 extend through the bridge 313 of the upper cap 310. A plurality of upper cap holes 314 may be provided. The plurality of upper cap holes 314 may be arranged at predetermined distances along a circumferential surface of a central portion of the upper cap 310.

The lower cap 320 may be positioned facing the upper cap 310 and may be electrically connected to the electrode assembly 200.

The lower cap 320 according to the current embodiment may be formed to have an approximately disk shape. The lower cap 320 may be arranged inside of the case 100. The lower cap 320 may be arranged under the upper cap 310. That is, the lower cap 320 may be arranged between the upper cap 310 and the electrode assembly 200. A central axis of the lower cap 320 may be coaxial with the central axis C of the case 100. A top surface of the lower cap 320 may be spaced from a bottom surface of the upper cap 310.

A cross-sectional area of the lower cap 320 may be less than a cross-sectional area of the electrode assembly 200 perpendicular to the central axis C of the case 100. However, the cross-sectional area of the lower cap 320 is not limited and may be equal to or greater than the cross-sectional area of the electrode assembly 200.

The lower cap 320 may include an electrically conductive material such as nickel, aluminum, copper, etc. The lower cap 320 may be electrically connected to the electrode assembly 200. For example, an end of the first electrode tab E1 extending from the first electrode 210 may be connected to a bottom surface of the lower cap 320 by various types of coupling methods such as welding, etc.

The lower cap 320 may be electrically connected to the upper cap 310 by the vent plate 330.

A lower cap hole 321 extending through the lower cap 320 upwardly and downwardly may be formed in the lower cap 320. The lower cap hole 321 may provide a path allowing gas, etc., generated inside the case 100 to pass through the lower cap 320 when, for example, an overcurrent occurs. A plurality of lower cap holes 321 may be provided, with the plurality of lower cap holes 321 may be arranged along a circumference centered on the central axis of the lower cap 320.

The vent plate 330 may be arranged between the upper cap 310 and the lower cap 320. The vent plate 330 may provide a current conducting path between the upper cap 310 and the lower cap 320 during a normal operation of the secondary battery 2. The vent plate 330 may include an electrically conductive material such as nickel, aluminum, copper, etc.

The vent plate 330 may be deformed by pressure from gas generated inside the case 100 when an overcurrent occurs, and the vent plate 330 may block the electrical connection between the upper cap 310 and the lower cap 320. The vent plate 330 may rupture when an internal pressure of the case 100 increases above a set level, opening a gas discharge path between the upper cap hole 314 and the lower cap hole 321.

The vent plate 330 may be formed to have an approximately disk shape.

The vent plate 330 may include a first vent surface 330a and a second vent surface 330b that are opposite to each other. The first vent surface 330a and the second vent surface 330b may be opposite surfaces of the vent plate 330 and perpendicular to the central axis C of the case 100. The first vent surface 330a may be arranged to face the upper cap 310, and the second vent surface 330b may be arranged to face the lower cap 320.

The vent plate 330 may include a contact portion 331. The contact portion 331 may protrude from the vent plate 330 toward the lower cap 320 and may contact with the lower cap 320. The contact portion 331 may function to electrically connect the vent plate 330 to the lower cap 320. Accordingly, current generated from the first electrode 210 may be transmitted to the upper cap 310 by way of the first electrode tab E1, the lower cap 320, the vent plate 330, and the extension portion 340.

The contact portion 331 may be arranged in a central portion of the vent plate 330. The central axis of the contact portion 331 may be coaxial with the central axis C of the case 100.

When the vent plate 330 is deformed due to an increase in the internal pressure of the case 100, the contact portion 331 may become separated from the lower cap 320. Thus, when an abnormal even such as an overcurrent occurs, the electrical connection between the lower cap 320 and the vent plate 330 may be disconnected.

The insulator 400 may be arranged between the vent plate 330 and the lower cap 320. The insulator 400 may prevent an area of the vent plate 330 (other than the contact portion 331) from contacting the lower cap 320. Accordingly, the insulator 400 may induce the electrical connection between the vent plate 330 and the lower cap 320 to be made through the contact portion 331.

The insulator 400 may be formed in a hollow-type ring shape. A central axis of the insulator 400 may be coaxial with the central axis C of the case 100 and the central axis of the vent plate 330. A top surface of the insulator 400 may contact a bottom surface of the vent plate 330, and a bottom surface of the insulator 400 may contact a top surface of the lower cap 320. The insulator 400 may include a crosslinked resin material. More specifically, the insulator 400 may be formed of an insulating material such as polyethylene (PE), polypropylene (PP), polyethylene terephthalate (PET), etc.

The extension portion 340 may extend from the vent plate 330 and may be connected to the upper cap 310. The extension portion 340 may function to support the vent plate 330 against the upper cap 310 and provide the electrical connection between the upper cap 310 and the vent plate 330. The extension portion 340 may be formed of the same material as the vent plate 330. In some embodiments, the extension portion 340 may be formed integrally with the vent plate 330. In other embodiments, the extension portion 340 may be made separately from the vent plate 330 and then coupled to the vent plate 330.

The extension portion 340 according to the current embodiment may include a support portion 341 and a first bent portion 342.

The support portion 341 may form a side exterior of the extension portion 340 and may be connected to the upper cap 310. The support portion 341 may be arranged to surround an end of the upper cap 310. More specifically, the support portion 341 may surround an edge area of the large-diameter portion 312. The support portion 341 may have a U-shaped cross-section. One end of the support portion 341 may contact the top surface of the large-diameter portion 312, and the other end of the support portion 341 may be bent downward to contact the bottom surface of the large-diameter portion 312. The support portion 341 may be coupled to the upper cap 310 by various ways such as laser welding, ultrasonic welding, resistance welding, etc.

The support portion 341 may be positioned facing the beading portion 140 in the first direction. For example, the support portion 341 may be arranged on the beading portion 140. Accordingly, when the secondary battery 2 is assembled, the beading portion 140 may limit the extent that the cap assembly 300 can be inserted into the inner side of the case 100 by a set distance or more.

The first bent portion 342 may form the other side exterior of the extension portion 340 and may be arranged between the support portion 341 and the vent plate 330. The first bent portion 342 may function to interconnect the support portion 341 to the vent plate 330 and guide deformation of the vent plate 330 when the internal pressure of the case 100 increases.

The first bent portion 342 may be a circular ring shape and may be arranged between the support portion 341 and the vent plate 330. An inner circumferential surface of the first bent portion 342 may be connected to the vent plate 330, and the outer circumferential surface of the first bent portion 342 may be connected to the other end of the support portion 341. The first bent portion 342 may extend stepwise in a direction from the outer circumferential surface toward the inner circumferential surface. In an example, the central portion of the first bent portion 342 may have a cross-section folded in a Z shape.

When an overcurrent occurs, the vent plate 330 may be deformed as a result of the first bent portion 342. For example, when the internal pressure of the case 100 increases due to overcurrent, gas passing through the lower cap hole 321 presses the vent plate 330 upward, and the vent plate 330 may be deformed into a shape in which a central portion thereof protrudes upwardly due to a change in a angle of the first bent portion 342.

The case 100 may further include a crimping portion 150 that fixes the position of the cap assembly 300 and prevents the cap assembly 300 from separating from the case 100.

The crimping portion 150 may extend from an upper end of the beading portion 140. An end of the crimping portion 150 may be bent toward the central axis C of the case 100. An inner surface of the crimping portion 150 may be arranged to surround an outer circumferential surface of the support portion 341.

A gasket G may be arranged between the crimping portion 150 and the cap assembly 300. The gasket G may function to electrically insulate the case 100 and the cap assembly 300 from each other and prevent moisture or an electrolyte from flowing in or out between the case 100 and the cap assembly 300.

The gasket G may be formed from an insulating material such as rubber, polyethylene (PE), polypropylene (PP), polyethylene terephthalate (PET), etc. The gasket G may be formed in ring shape. The gasket G may have a cross-section that is U-shaped. An outer surface of the gasket G may be in contact with the inner surfaces of the crimping portion 150 and the beading portion 140. The inner surface of the gasket G may surround the outer surface of the support portion 341 and may be in contact with the outer surface of the support portion 341.

A concave notch 350 may be formed in at least any one of the first vent surface 330a or the second vent surface 330b. In the depicted embodiment, the notch 350 may be formed concave from the first vent surface 330a.

The notch 350 may have a concave groove shape in a direction from the first vent surface 330a toward the second vent surface 330b. The notch 350 may be formed in a ring shape along an arc centered on the central axis C of the case 100.

A width of the notch 350 may decrease toward the second vent surface 330b. For example, the cross-sectional shape of the notch 350 may have a trapezoidal shape in which a width of an end facing the second vent surface 330b is less than a width of an end penetrating the first vent surface 330a.

Although not shown, in other embodiments a notch may be formed concave from the second vent surface 330b.

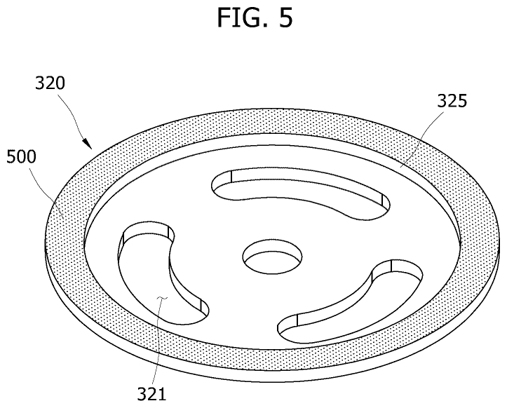

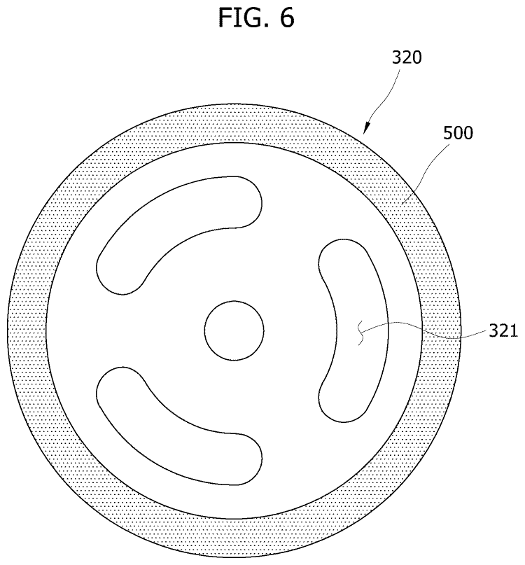

FIG. 5 is a perspective view of a lower cap according to the first embodiment of the present disclosure, and FIG. 6 is a plan view schematically showing the structure of the lower cap according to the first embodiment of the present disclosure.

An anti-rotation portion 500 of the lower cap 320 may function to prevent relative rotation of the vent plate 330 and the lower cap 320. That is, the anti-rotation portion 500 may provide increased friction between the insulator 400 and the lower cap 320 to maintain binding. In an example, the anti-rotation portion 500 may be formed by a surface treatment of the lower cap 320 part that faces the insulator 400. The surface treatment may be a series of processes performed to change or improve the surface properties of a metal. For example, surface treatment may improve surface roughness through sandblasting or etching to increase the frictional force.

On opposite sides of the lower cap 320, a second bent portion 325 corresponding to the first bent portion 342 of the vent plate 330 may be formed. That is, the lower cap 320 may be formed stepwise by the second bent portion 325, and the anti-rotation portion 500 may be formed on the outer top surface with respect to the second bent portion 325 of the lower cap 320 to increase the frictional force between the insulator 400 and the lower cap 320. Thus, the lower cap 320 can maintain binding in the secondary battery 2.

A secondary battery 2 according to a second embodiment of the present disclosure will now be described. The secondary battery 2 according to the second embodiment may be configured different from the secondary battery 2 according to the first embodiment of the present disclosure with respect to the anti-rotation portion 500. In describing the secondary battery 2 according to the second embodiment, only the detailed configuration of the anti-rotation portion 500 will be described. For the rest of the configuration of the secondary battery 2 according to the second embodiment, the description of the secondary battery 2 according to the first embodiment of the disclosure may be applied.

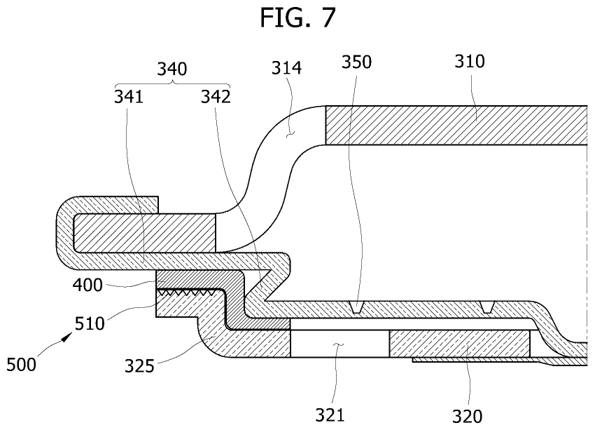

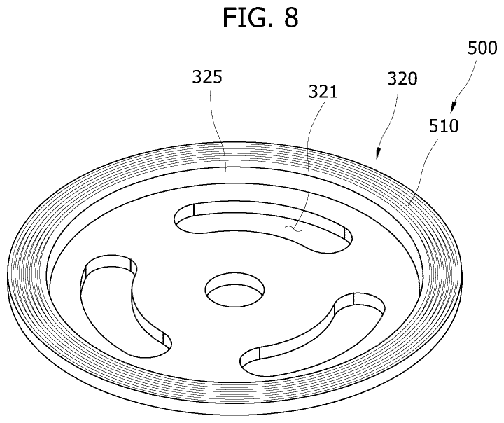

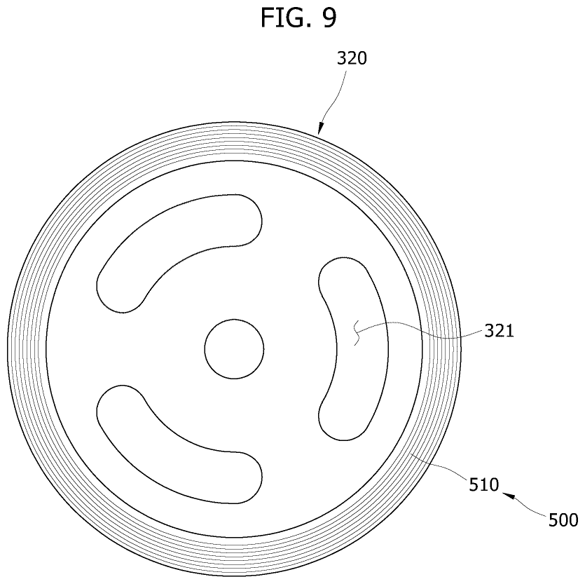

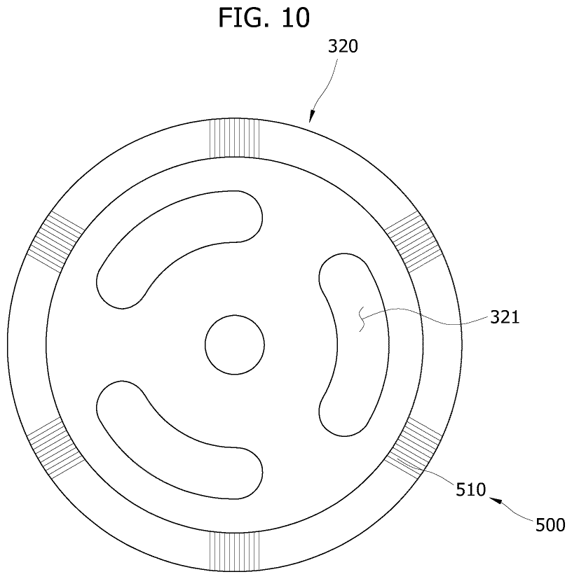

FIG. 7 is an enlarged view of a half region of a cap assembly according to a second embodiment of the present disclosure, FIG. 8 is a perspective view schematically showing a structure of a lower cap according to the second embodiment of the present disclosure, and FIG. 9 is a plan view schematically showing the structure of the lower cap according to the second embodiment of the present disclosure.

Referring to FIGS. 7 through 9, the anti-rotation portion 500 according to the second embodiment of the present disclosure may function to prevent relative rotation of the vent plate 330 and the lower cap 320. That is, the anti-rotation portion 500 may provide increased friction between the insulator 400 and the lower cap 320 to maintain binding.

The anti-rotation portion 500 may be formed by punching the lower cap 320 facing the insulator 400. Punching is a process that mechanically presses metal to create a physically protruding structure or hole. In this case, punching the anti-rotation portion 500 increases the frictional force provided by the structure.

On the opposite sides of the lower cap 320, the second bent portion 325 corresponding to the first bent portion 342 of the vent plate 330 may be formed. That is, the lower cap 320 may be formed stepwise by the second bent portion 325, and an uneven portion 510 may be formed on the outer top surface with respect to the second bent portion 325 of the lower cap 320 to increase the frictional force between the insulator 400 and the lower cap 320, thus maintaining binding. The uneven portion 510 may be formed to have peaks and valleys toward the center of the lower cap 320. In other words, the uneven portion 510 may be formed by punching a top surface of the lower cap 320, which is formed in a circular shape of a metallic material, and the peaks and valleys may be formed in a band shape in a circumferential direction of the lower cap 320.

The uneven portion 510 formed on the metallic lower cap 320 may contact the bottom surface of the resinous insulator 400 to increase a friction force. Thus, failures caused by a rotational force and vibration in the secondary battery 2 may be reduced.

FIG. 10 is a plan view schematically showing a modified example of the lower cap according to the second embodiment of the present disclosure. Referring to FIG. 10, the uneven portion 510 formed on the lower cap 320 may be formed to have peaks and valleys continuously formed in the circumferential direction of the lower cap 320. The lower cap 320 may be formed stepwise by the second bent portion 325, and an uneven portion 510 may be formed on the outer top surface with respect to the second bent portion 325 of the lower cap 320 to increase the frictional force between the insulator 400 and the lower cap 320, thus maintaining binding in the secondary battery 2. A plurality of uneven portions 510 according to a modified example may be formed in a radial direction of the lower cap 320. As a result, the uneven portion 510 formed on the metallic lower cap 320 may be formed on the bottom surface of the resinous insulator 400 orthogonally to the circumferential direction to increase a friction force Thus, failures caused by a rotational force and vibration in the secondary battery 2 may be reduced.

Hereinbelow, the secondary battery 2 according to a third embodiment of the present disclosure will be described. The secondary battery 2 according to the third embodiment may be configured different from the secondary battery 2 with respect to the configuration of the anti-rotation portion 500. Accordingly, in describing the secondary battery 2 according to the third embodiment, only the detailed configuration of the anti-rotation portion 500, which is different from the secondary battery 2 according to the first embodiment of the present disclosure, will be described. For the rest of the configuration of the secondary battery 2 according to the third embodiment, the description of the secondary battery 2 according to the first embodiment of the disclosure may be applied.

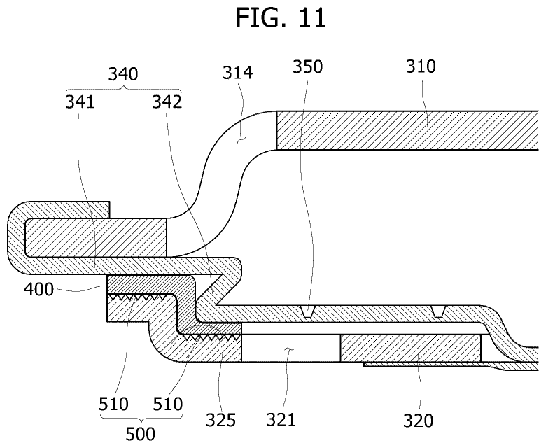

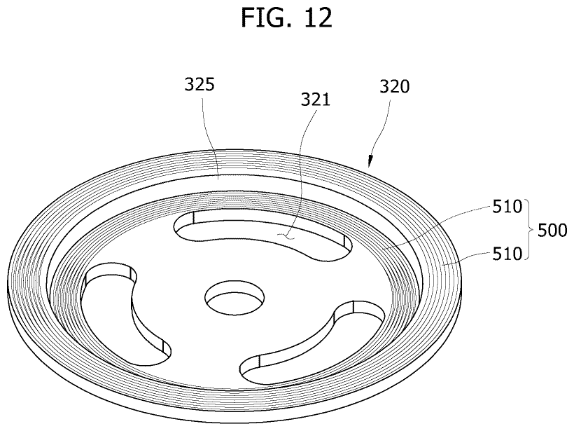

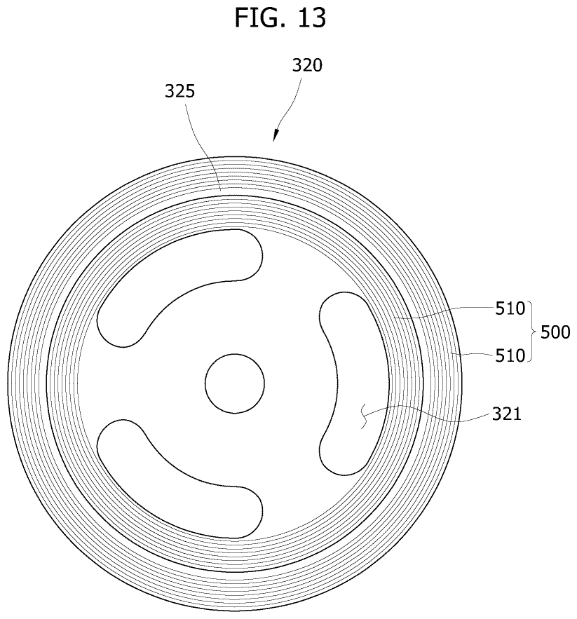

FIG. 11 is an enlarged view of a half region of a cap assembly according to the third embodiment of the present disclosure, FIG. 12 is a perspective view schematically showing a structure of a lower cap according to the third embodiment of the present disclosure, and FIG. 13 is a plan view schematically showing the structure of the lower cap according to the third embodiment of the present disclosure.

Referring to FIGS. 11 through 13, the anti-rotation portion 500 according to the third embodiment of the present disclosure may function to prevent relative rotation of the vent plate 330 and the lower cap 320. That is, the anti-rotation portion 500 may provide increased friction between the insulator 400 and the lower cap 320 to maintain binding in the secondary battery 2.

The anti-rotation portion 500 may be formed by punching with respect to the lower cap 320 facing the insulator 400. As noted above, punching is a process that mechanically presses metal to create a physically protruding structure or hole; punching may be used in this case to form the anti-rotation portion 500 to thereby increase the frictional force.

The anti-rotation portion 500 according to the third embodiment may further include friction elements to secure a larger area as compared to the anti-rotation portion 500 according to the first and second embodiments. Thus, the anti-rotation portion 500 may provide increased frictional force.

On opposite sides of the lower cap 320, a second bent portion 325 corresponding to the first bent portion 342 of the vent plate 330 may be formed. The lower cap 320 may be formed stepwise by the second bent portion 325, and the uneven portion 510 may be formed on opposite sides with respect to the second bent portion 325 of the lower cap 320. That is, the lower cap 320 may be divided into an upper end and a lower end by the second bent portion 325, and the uneven portion 510 may be formed on the upper end and the lower end. By forming the uneven portion 510 over a larger area, the frictional force between the insulator 400 and the lower cap 320 may be further increased to thereby further maintain binding.

The uneven portion 510 may be formed to have peaks and valleys toward the center of the lower cap 320. In other words, the uneven portion 510 may be formed by punching a top surface of the lower cap 320, which is formed in a circular shape of a metallic material, and the peaks and valleys may be formed in a band shape in a circumferential direction.

As a result, the uneven portion 510 formed on the metallic lower cap 320 may contact the bottom surface of the resinous insulator 400 with increased friction force, thereby reducing failures caused by a rotational force and vibration in the secondary battery.

Although not shown, the uneven portion 510 formed on the lower cap 320 may be formed to have peaks and valleys continuously formed in the circumferential direction of the lower cap 320, as in the modified example of the second embodiment.

Hereinbelow, the secondary battery 2 according to a fourth embodiment of the present disclosure will be described. The secondary battery 2 according to the fourth embodiment may be configured different from the secondary battery 2 according to the first embodiment of the present disclosure with respect to the configuration of the anti-rotation portion 500. Accordingly, in describing the secondary battery 2 according to the fourth embodiment, only the detailed configuration of the anti-rotation portion 500, which is different from the secondary battery 2 according to the first embodiment of the present disclosure, will be described. For the rest of the configuration of the secondary battery 2 according to the fourth embodiment, the description of the secondary battery 2 according to the first embodiment of the disclosure may be applied.

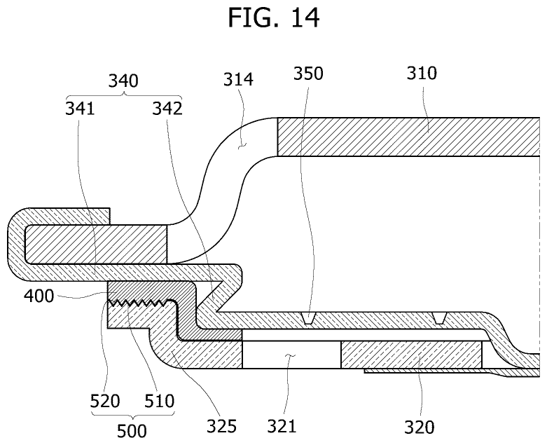

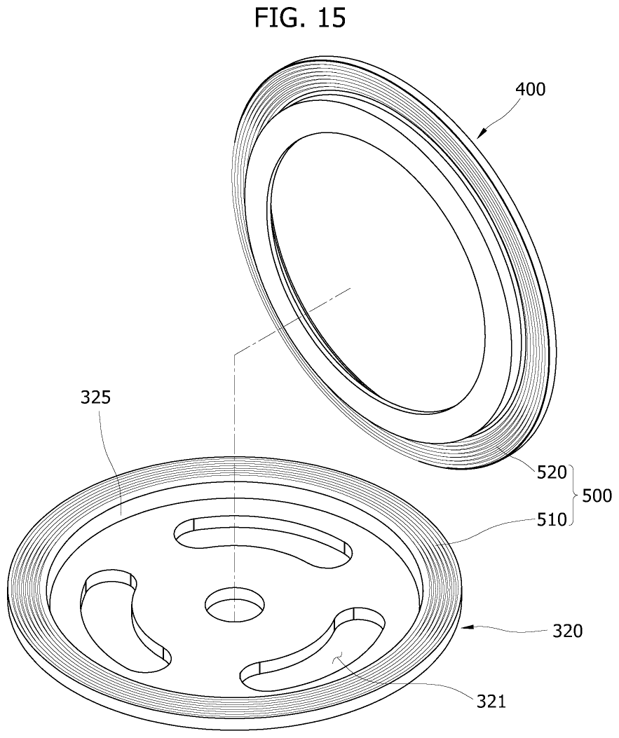

FIG. 14 is an enlarged view of a half region of a cap assembly according to a fourth embodiment of the present disclosure, and FIG. 15 is an exploded perspective view schematically showing a structure of an insulator and a structure of a lower cap according to a fourth embodiment of the present disclosure.

Referring to FIGS. 14 and 15, the anti-rotation portion 500 according to the fourth embodiment of the present disclosure may function to prevent relative rotation of the vent plate 330 and the lower cap 320. That is, the anti-rotation portion 500 may provide increased frictional force between the insulator 400 and the lower cap 320 to maintain binding.

The anti-rotation portion 500 may be formed by punching (as described above) with respect to the lower cap 320 facing the insulator 400.

The anti-rotation portion 500 according to the current embodiment may be the uneven portion 510 formed on the lower cap 320.

On opposite sides of the lower cap 320, a second bent portion 325 corresponding to the first bent portion 342 of the vent plate 330 may be formed. The lower cap 320 may be formed stepwise by the second bent portion 325, and the uneven portion 510 may be formed on an outer side with respect to the second bent portion 325 of the lower cap 320.

The uneven portion 510 may be formed to have peaks and valleys toward the center of the lower cap 320. In other words, the uneven portion 510 may be formed by punching the lower cap 320, which is formed in a circular shape of a metallic material, and the peaks and valleys may be formed in a band shape in the circumferential direction.

The anti-rotation portion 500 according to the fourth embodiment may include a protrusion portion 520 formed on the insulator 400r, with the protrusion portion 520 corresponding to the uneven portion 510 of the lower cap 320. The protrusion portion 520 may also be formed to have peaks and valleys toward the center of the insulator 400 to correspond to the uneven portion 510 of the lower cap 320 such that the uneven portion 510 and the protrusion portion 520 may be engaged with each other.

The engagement of the uneven portion 510 and the protrusion portion 520 increases a contact area, thus reducing failures caused by a rotational force and vibration in the secondary battery.

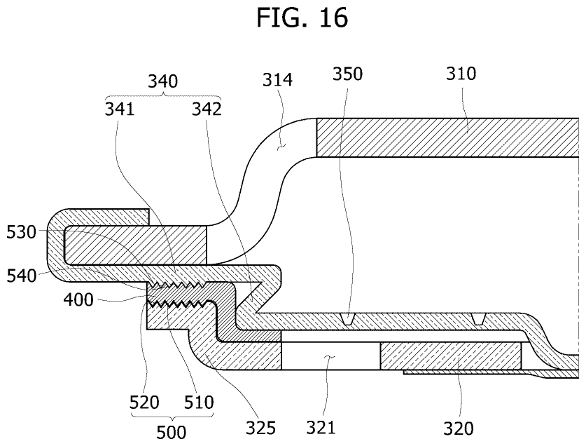

FIG. 16 is a view schematically showing a modified example of a cap assembly according to the fourth embodiment of the present disclosure. Referring to FIG. 16, the anti-rotation portion 500 may further include a reinforced uneven portion 530 formed on the vent plate 330 facing the insulator 400. The anti-rotation portion 500 may further include a reinforced protrusion portion 540 to be received in the reinforced uneven portion 530.

That is, the protrusion portion 520 formed on the bottom surface of the insulator 400 may be engaged with the uneven portion 510 of the lower cap 320, and the reinforced protrusion portion 540 formed on the top surface of the insulator 400 may be engaged with the reinforced uneven portion 530 formed on the bottom surface of the vent plate 330. The additional friction elements increase the frictional force, and thereby reducing failures caused by a rotational force and vibration in the secondary battery 2.

Hereinbelow, the secondary battery 2 according to a fifth embodiment of the present disclosure will be described. The secondary battery 2 according to the fifth embodiment may be configured different from the secondary battery 2 according to the first embodiment of the present disclosure with respect to the configuration of the insulator 400. Accordingly, in describing the secondary battery 2 according to the fifth embodiment, only the detailed configuration of the insulator 400, which is different from the secondary battery 2 according to the first embodiment of the present disclosure, will be described. For the rest of the configuration of the secondary battery 2 according to the fifth embodiment, the description of the secondary battery 2 according to the first embodiment of the disclosure may be applied.

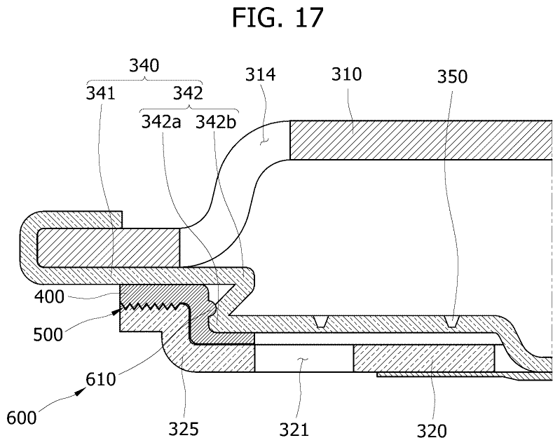

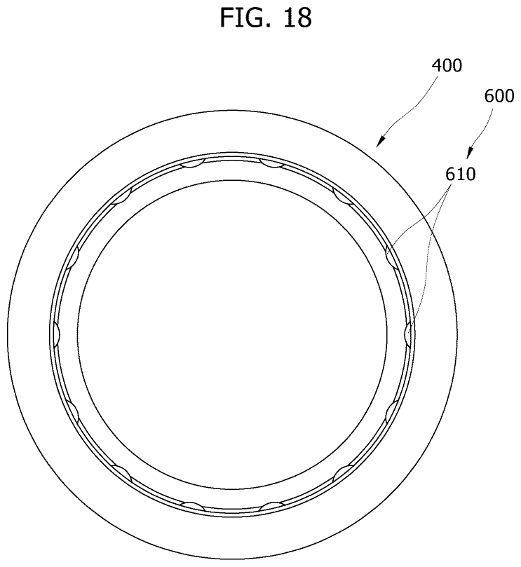

FIG. 17 is an enlarged view of a half region of a cap assembly according to a fifth embodiment of the present disclosure, and FIG. 18 is a plan view schematically showing a structure of an insulator according to the fifth embodiment of the present disclosure.

Referring to FIGS. 17 and 18, the insulator 400 according to the fifth embodiment of the present disclosure may include a binding portion 600 that maintains binding with the vent plate 330.

On opposite sides of the vent plate 330, the first bent portion 342 may be formed, and on opposite sides of the lower cap 320, the second bent portion 325 corresponding to the first bent portion 342 may be formed. The insulator 400 may be forcedly fitted between the first bent portion 342 and the second bent portion 325.

The binding maintaining portion 600 may include a projection 610 that projects toward the center of the insulator 400 and is supported on the first bent portion 342.

The first bent portion 342 may be arranged between the support 341 and the vent plate 330. The first bent portion 342 may have a Z-shape including a lower bent portion 342a and an upper bent portion 342b. The projection 610 may be engaged with an upper portion of the lower bent portion 342a.

With the configuration of the fifth embodiment, upward and downward movement of the lower cap 320 may be inhibited by the forced fitting of the insulator 400 and the binding maintaining portion 600. It is also possible to prevent the vent plate 330 from separating from the insulator 400. This may originate from a structure in which the lower bent portion 342a and the upper bent portion 342b are bent at acute angles in a Z shape.

A plurality of projections 610 may protrude from the inner circumferential surface of the insulator 400 toward the center thereof and may be spaced apart from each other. By having the plurality of projections 610 be spaced apart from each other and the insulator 400 being forcedly fitted to the first bent portion 342, rotation of the lower cap 320 may be prevented.

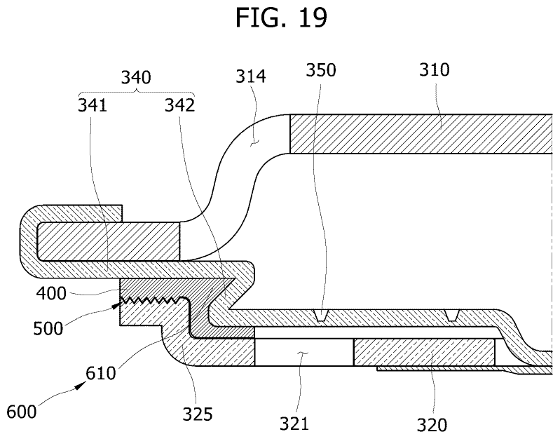

FIG. 19 is an enlarged view of a modified example of the half region of the cap assembly according to the fifth embodiment of the present disclosure.

Referring to FIG. 19, the binding maintaining portion 600 may be formed by filling a part of the insulator 400 in the first bent portion 342 by thermal deformation of the insulator 400. That is, a portion of the insulator 400 corresponding to the first bent portion 342 may be inserted into the first bent portion 342 by a change in shape due to thermal deformation. Thus, the first bent portion 342 may inhibit upward and downward movement and rotation of the lower cap 320.

A battery pack including the secondary battery 2 will now be described.

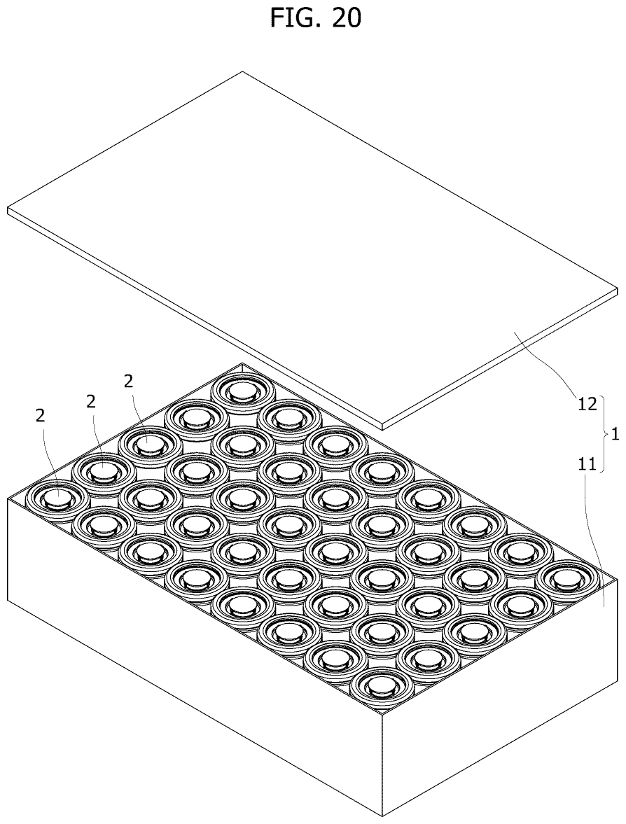

FIG. 20 is a perspective view of a battery pack according to various embodiments of the present disclosure.

Referring to FIG. 20, a battery pack according to an embodiment may include a housing 1 and the secondary battery 2. The housing 1 may form an exterior of the battery pack and may provide a space in which the secondary battery 2 may be received. The housing 1 according to the current embodiment may include a housing body 11 and a cover 12.

The housing body 11 may be a box having a hollow inner side and one open side.

The cover 12 may be coupled to the housing body 11 and may close an inner space of the housing body 11. The cover 12 may be formed in a plate shape may be arranged to face the open side of the housing body 11. The cover 12 may be fixed to the housing body 11 by various types of coupling methods, such as bolting, welding, fitting, and the like.

Secondary batteries 2 may be arranged inside the housing 1. The secondary batteries 2 may be any one of the secondary batteries 2 according to the first through fifth embodiments described above. The plurality of secondary batteries 2 may be arranged to have various patterns such as a lattice form, a zigzag form, etc., inside the housing 1. The plurality of secondary batteries 2 may be arranged side by side. The number of secondary batteries 2 may be changed depending on the size, shape, etc., of the housing 1.

The plurality of secondary batteries 2 may be electrically connected by a bus bar (not shown). More specifically, the plurality of secondary batteries 2 may be connected in series or in parallel by the bus bar. For example, the bus bar may connect the secondary batteries 2, arranged in the same column inside the housing 1, in parallel to each other, and the secondary batteries 2, arranged in two adjacent columns, in series with each other. The bus bar may be formed of electrically conductive materials such as copper, aluminum, nickel, etc.

According to the present disclosure, by suppressing movement of a current interrupt device (CID), the performance of the CID may be stably secured.

According to the present disclosure, binding between the lower cap and the insulator may be maintained by a frictional force, thereby reducing failures caused by a rotational force and vibration.

While the present disclosure has been described with reference to embodiments shown in the drawings, these embodiments are merely illustrative. Various modifications and equivalent other embodiments can be derived by those skilled in the art on the basis of the embodiments.

What is claimed is:

1. A secondary battery comprising:
a case with an opening;
an electrode assembly arranged inside the case;
an upper cap arranged in the opening;
a lower cap arranged to face the upper cap and connected to the electrode assembly;
a vent plate arranged between the upper cap and the lower cap;
an insulator arranged between the vent plate and the lower cap; and
an anti-rotation portion that prevents relative rotation of the vent plate and the lower cap.

2. The second battery as claimed in claim 1, wherein the vent plate further comprises:
a first vent surface arranged to face the upper cap; and
a second vent surface arranged to face the lower cap.

3. The second battery as claimed in claim 2, wherein a concave notch is formed in the first vent surface or the second vent surface.

4. The second battery as claimed in claim 1, wherein the insulator comprises a crosslinked resin material.

5. The second battery as claimed in claim 1, wherein the anti-rotation portion is formed by surface treatment of a part of the lower cap that faces the insulator.

6. The second battery as claimed in claim 1, wherein the anti-rotation portion is formed by punching of a part of the lower cap that faces the insulator.

7. The second battery as claimed in claim 1, wherein the anti-rotation portion comprises an uneven portion formed on the lower cap.

8. The second battery as claimed in claim 7, wherein the uneven portion comprises peaks and valleys continuously formed toward a center of the lower cap.

9. The second battery as claimed in claim 7, wherein the uneven portion comprises peaks and valleys continuously formed in a circumferential direction of the lower cap.

10. The second battery as claimed in claim 7, wherein the anti-rotation portion comprises a protrusion portion formed on the insulator, with the protrusion portion being received in the uneven portion.

11. The second battery as claimed in claim 7, wherein the anti-rotation portion comprises a reinforced uneven portion formed on a part of the vent plate that faces the insulator.

12. The second battery as claimed in claim 11, wherein the anti-rotation portion comprises a reinforced protrusion portion formed on the insulator, with the reinforced protrusion portion being received in the reinforced uneven portion.

13. The second battery as claimed in claim 1, wherein a first bent portion is formed on opposite sides of the vent plate,
wherein a second bent portion is formed on opposite sides of the lower cap to correspond to the first bent portion, and
whereinthe insulator is forcedly fit between the first bent portion and the second bent portion.

14. The second battery as claimed in claim 13, wherein the insulator comprises a binding maintaining portion to maintain binding with the vent plate.

15. The second battery as claimed in claim 14, wherein the binding maintaining portion comprises a projection that protrudes toward a center of the insulator and is supported on the first bent portion.

16. The secondary battery as claimed in claim 15, wherein the first bent portion has a Z-shape bent structure comprising a lower bent portion and an upper bent portion, and the projection is engaged with an upper portion of the lower bent portion.

17. The secondary battery as claimed in claim 15, wherein a plurality of projections protrude toward the center of the insulator from an inner circumferential surface of the insulator, with the projections being spaced from each other.

18. The second battery as claimed in claim 14, wherein the binding maintaining portion is formed by a part of the first bent portion being deformed by thermal deformation to fill a part of the insulator.

19. A battery pack comprising:
a housing; and
secondary batteries arranged inside the housing,
wherein each of the secondary batteries comprises:
a case comprising an opening portion;
an electrode assembly arranged inside the case;
an upper cap arranged in the opening portion;
a lower cap arranged to face the upper cap and connected to the electrode assembly;
a vent plate arranged between the upper cap and the lower cap;
an insulator arranged between the vent plate and the lower cap; and
an anti-rotation portion that prevents relative rotation of the vent plate and the lower cap.

20. The battery pack as claimed in claim 19, wherein the anti-rotation portion is formed by surface treatment or punching a part of the lower cap that faces the insulator.
